(19) United States
(12) Patent Application Publication
(10) Pub. No.: US 2014/0049097 A1
(43) Pub. Date: Feb. 20, 2014

(54) MANUFACTURING METHOD OF A BICYCLE WHEEL RIM

(71) Applicants: Chun-San LIN, Taichung (TW); Chang-Hsuan Chiu, Taichung (TW)

(72) Inventors: Chun-San LIN, Taichung (TW); Chang-Hsuan Chiu, Taichung (TW)

(21) Appl. No.: 13/589,433

(22) Filed: Aug. 20, 2012

(51) Int. Cl. B29C 65/02; B60B 5/02

(52) U.S. Cl. 301/95.102; 156/182

(57) ABSTRACT

A method for manufacturing a bicycle wheel rim includes: (a) providing a first mold assembly which includes an inner mold and an outer mold, the outer mold having an annular first forming face to surround an annular second forming face of the inner mold; (b) disposing annularly a first prepreg preform that overlie annularly and respectively the annular first and second forming faces; (c) causing the first and second forming faces to press the concaved faces and thermoforming the first prepreg preform to obtain an annular outer rim part; (d) forming a second prepreg preform into an annular inner rim part; and (e) combining the annular outer rim part with the annular inner rim part to form a wheel rim.

### BACKGROUND OF THE INVENTION

1. Field of the Invention

This invention relates to a method for manufacturing a bicycle wheel rim, more particularly to a method for manufacturing a bicycle wheel rim with better production yield and thermal resistance.

2. Description of the Related Art

Components of a bicycle are constantly lightened in order to increase riding speed. Therefore, conventional aluminum wheel rims are gradually replaced by wheel rims made of a carbon fiber composite material.

FIG. 1 shows a conventional method for manufacturing a wheel rim 63 made of a carbon fiber composite material. The wheel rim 63 with an inner rim part 632 and an outer rim part 631 is integrally formed by disposing a carbon fiber composite material between an air bag 61 and a silicon mold 62 followed by thermoforming. The air bag 61 is susceptible to high temperature damage which can cause the wheel rim 63 unable to be formed. Therefore, resins with low forming temperature are used in the carbon fiber composite material to form the wheel rim 63. However, the resins with low forming temperature are likely to be damaged by heat generated by brake pad friction, and thus the wheel rim 63 has unsatisfactory long term durability. Besides, form error is a great problem for the wheel rim 63 since two soft materials, the air bag 61 and the silicone mold 62, are used as molds. Moreover, since the outer and inner rim part 631, 632 are simultaneously formed, damage to one of the outer and inner rim part 631, 632 will cause discard of the complete wheel rim 63, thereby resulting in lower production yield.

FIG. 2 shows another conventional method for manufacturing a wheel rim. The method shown in FIG. 2 is similar to the aforesaid method shown in FIG. 1 except that a metal mold assembly 65 is used to replace the silicone mold 62. The metal mold assembly 65 includes a core mold element 651 and two annular mold elements 652 which are spaced apart from each other axially. A carbon fiber composite material is disposed between an air bag 64 and the metal mold assembly 65 for thermoforming. Form error in this method is reduced due to rigidity of the metal mold assembly 65. In this conventional method, the core mold element 651 has a first region that abuts against the two annular mold elements 652 to force the two annular mold elements 652 to equally expand the carbon fiber composite material. In the metal mold assembly 65, after the wheel rim is formed, the core mold element 651 is difficult to remove from the annular mold elements 652 due to the large friction between the core mold element 651 and the annular mold elements 652. Meanwhile, this method also has thermal resistance and production yield problems as encountered in the prior art show in FIG. 1.

### SUMMARY OF THE INVENTION

The object of the present invention is to provide a method for manufacturing a bicycle wheel rim and a bicycle wheel rim made therefrom.

According to one aspect of the present invention, there is provided a method for manufacturing a bicycle wheel rim that includes an annular inner rim part and an annular outer rim part. The method includes the following steps:
(a) providing a first mold assembly which includes an inner mold and an outer mold extending annularly around the inner mold, the outer mold having an annular first forming face to surround an annular second forming face of the inner mold;
(b) disposing annularly a first prepreg preform between the annular first and second forming faces, the first prepreg preform having a substantially H-shape in cross section and including two back to back disposed concaved faces that overlie annularly and respectively the first and second forming faces;
(c) causing the first and second forming faces to press the concaved faces and thermoforming the first prepreg preform to obtain the annular outer rim part;
(d) forming a second prepreg preform into the annular inner rim part; and
(e) combining the annular outer rim part with the annular inner rim part to form the wheel rim.

According to another aspect of the present invention, there is provided a bicycle wheel rim made from the aforesaid method. The bicycle wheel rim includes an annular inner rim part including an annular body with a substantially hollow triangle shape in cross section, the annular body being tapered radially from an outer end thereof to an inner end thereof; and an annular outer rim part having a substantially H-shape in cross section, and including two back-to-back disposed concaved faces, one of the concaved faces receiving and abutting against the outer end of the annular body.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view illustrating a conventional method for manufacturing a bicycle wheel rim;

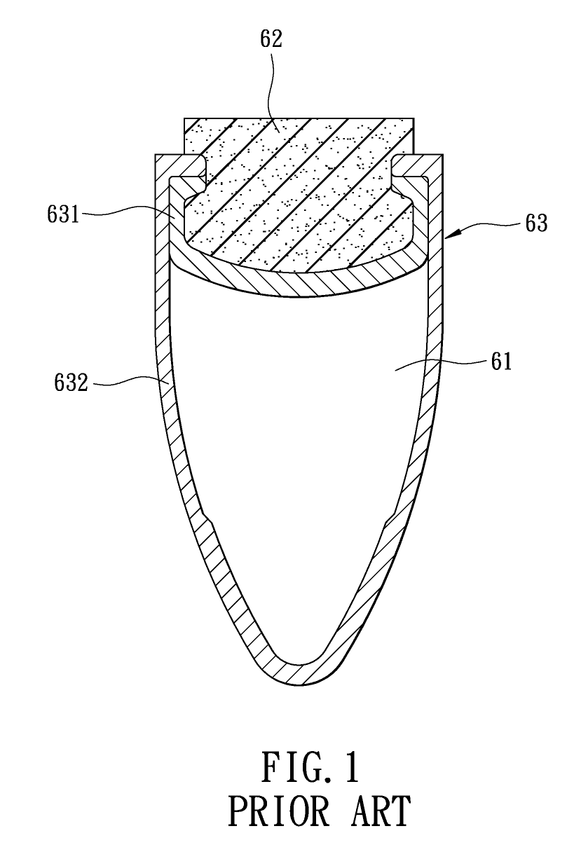

FIG. 2 is a sectional view showing another conventional method for manufacturing a bicycle wheel rim;

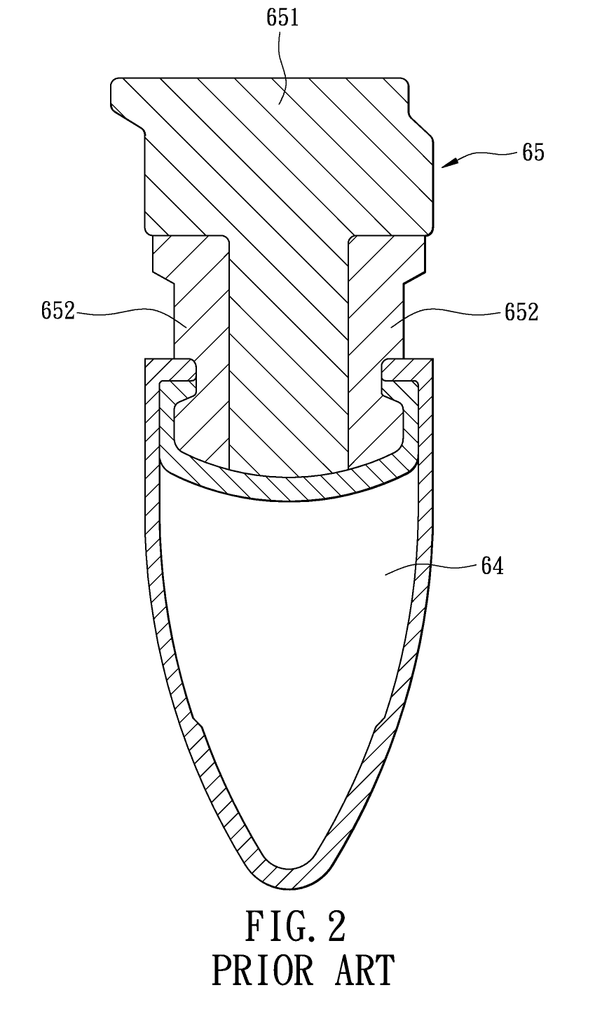

FIG. 3 is a flow chart of the first preferred embodiment of a method for manufacturing a bicycle wheel rim;

FIG. 4 is a sectional view of the first preferred embodiment showing a step of forming an annular outer rim part using a first mold assembly;

FIG. 5 is a sectional view of the first preferred embodiment illustrating a step of forming an annular outer rim part and uniting the annular outer and inner rim parts;

FIG. 6 is a sectional view of a wheel rim manufactured by the first preferred embodiment;

FIG. 7 is a flow chart of the second preferred embodiment of a method for manufacturing a bicycle wheel rim; and

FIG. 8 is a sectional view of the second preferred embodiment illustrating a step of forming an annular inner rim part in a second mold.

### DETAILED DESCRIPTION OF THE PREFERRED EMBODIMENTS

Before the present invention is described in greater detail, it should be noted that like elements are denoted by the same reference numerals throughout the disclosure.

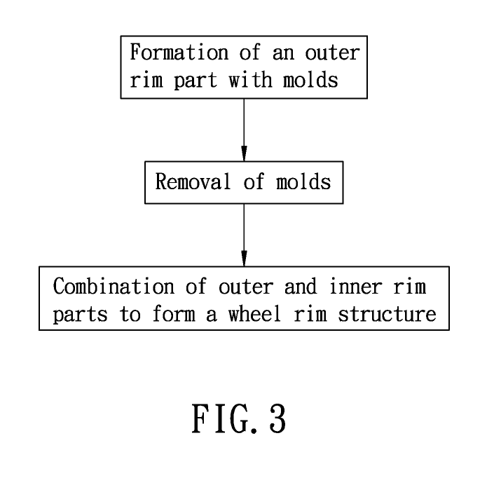

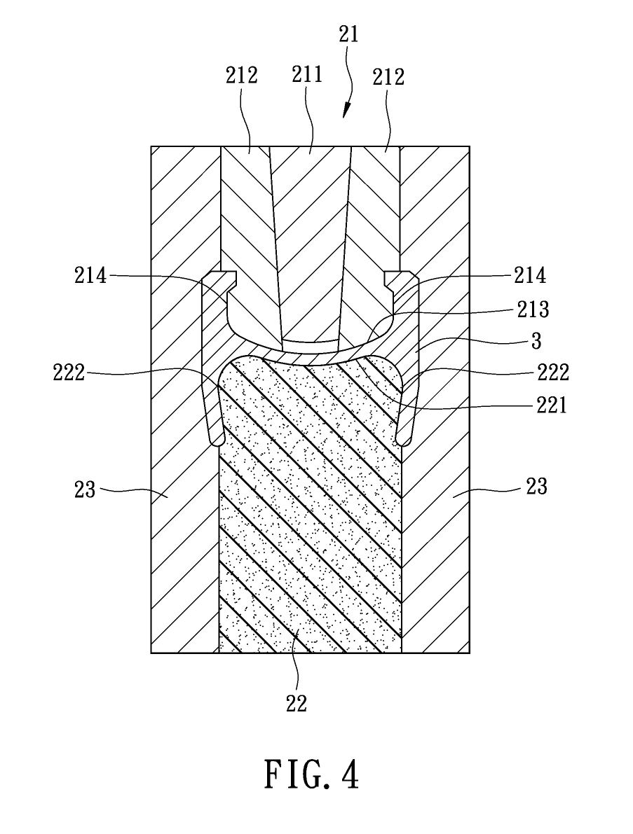

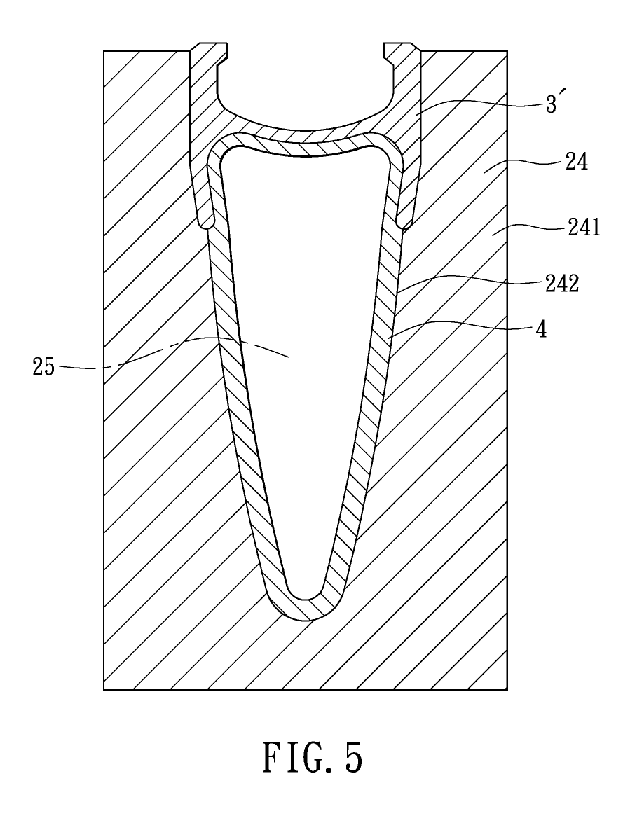

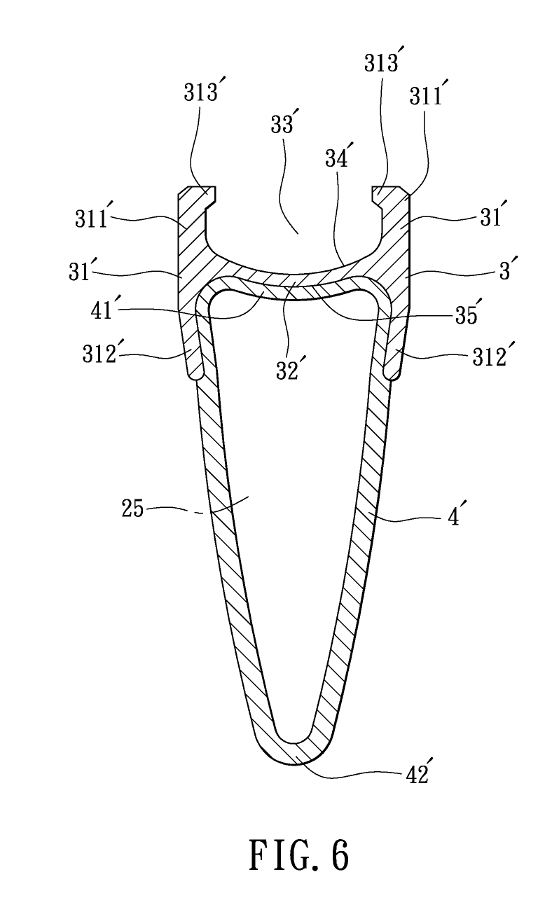

FIGS. 3, 4, and 5 illustrate the first preferred embodiment of a method for manufacturing a wheel rim of this invention. The wheel rim includes an annular inner rim part 4′ and an annular outer rim part 3′ surrounding the annular inner rim part 4′ (see FIG. 6). The method of the first preferred embodiment includes forming the annular outer rim part 3′ using a first mold assembly, removing the first mold assembly, and forming the annular inner rim part 4′ using a second mold and the annular outer rim part 3′ and simultaneously connecting the annular outer and inner rim parts 3′, 4′.

The first mold assembly used to form the annular outer rim part 3′ includes an outer mold 21 having an annular first forming face, an inner mold 22 having an annular second forming face, and two side modes 23. The outer mold 21 is made from metal, and the inner mold 22 is made from rubber. The outer mold 21 extends annularly around the inner mold 22 such that the annular first forming face surrounds the annular second forming face. The annular first forming face has an annular first end face 213 and two first lateral faces 214. The annular second forming face has an annular second end face 221 and two second lateral faces 222. The annular first and second end faces 213, 221 confront each other in a radial direction. The first lateral faces 214 extend radially outward from two opposite sides of the first end face 213, and the second lateral faces 222 extend radially inward from two opposite sides of the second end face 221.

The outer mold 21 further includes two annular mold elements 212 that are spaced apart from each other axially, and a core mold element 211 disposed between the annular mold elements 212. The annular mold elements 212 respectively define the first lateral faces 214 and cooperatively define the first end face 213. The core mold element 211 is movable between a wedging position and an un-wedging position, and is tapered radially and toward the first end face 213. The core mold element 211 is spaced apart from the annular first end face 213 by a distance in the wedging position.

A first prepreg preform 3 made from fiber and resin is disposed annularly between the annular first and second forming faces. The first prepreg preform 3 has a substantially H-shape in cross section and includes two back to back disposed concaved faces that overlie annularly and respectively the first and second forming faces. The two side modes 23 are then disposed on two axially opposed sides of the outer and inner modes to press the first prepreg preform 3 against the respective lateral faces 214, 222 of the outer and inner modes 21, 22. Specifically, in the first mold assembly in which the core mold element 211 is disposed in the wedging position, the first and second forming faces of the outer and inner molds 21, 22 press the concaved faces of the first prepreg preform 3.

Thereafter, a thermoforming is conducted at 180° C. to form the first prepreg preform 3 into the annular outer rim part 3′.

After thermoforming, the core mold element 211 is firstly removed followed by removing the annular mold elements 212. After the outer mold 21 is removed, the inner mold 22 and the side molds 23 are then removed in sequence.

A second prepreg preform 4 covered on and contacts an entire surface of an inflated air bag 25 and the outer rim part 3′ are placed in a second mold. The second mold 24 includes a mold body 241 having an inner surface 242 to define a cavity. The inflated air bag 25 covered with the second prepreg preform 4 is disposed in the cavity.

In the first preferred embodiment, the outer rim part 3′ is used as a mold in this step and annularly surrounds and contacts the second prepreg preform 4. In the second mold 24, the inflated air bag 25 pressures the second prepreg preform 4 to press the second prepreg preform 4 against the inner surface 242 of the mold body 241 and against the outer rim part 3′. Thermoforming is carried out to form the second prepreg preform 4 into the annular inner rim part 4′ and simultaneously to unite the inner rim part 4′ with the outer rim part 3′ so as to form a wheel rim shown in FIG. 6.

As shown in FIG. 6, the wheel rim includes the annular inner rim part 4′ and the annular outer rim part 3′. The annular inner rim part 4′ includes an annular body with a substantially hollow triangle shape in cross section, and surrounds the inflated air bag 25. The annular body is tapered radially from an outer end 41′ thereof to an inner end 42′ thereof. The annular outer rim part 3′ has a substantially H-shape in cross section and includes two annular side walls 31′ and an annular connecting wall 32′ connecting the two annular side walls 31′. The side walls 31′ has two outer part 311′ extend radially outward from two opposite sides of the connecting wall 32′, and two inner parts 312 extend radially inward from the two opposite sides of the connecting wall 32′. The inner parts 312′ together with the connecting wall 32′ define a first concaved face 35′ which receives and abuts against the outer end 41′ of the annular body of the annular inner rim part 4′. The outer parts 311′ together with the connected wall 32′ define a second concaved face 34′. The second concaved face 34′ defines a tire retaining space 33′. The first and second concaved faces 34′ and 35′ are back-to-back disposed. The annular outer rim part 3′ further includes two fixing parts 313′ each of which extends toward the tire retaining space 33′ from an end portion of the outer part 311′ of a respective one of the annular side walls 31′ to fix a tire received in the tire retaining space 33′.

In practical use, an inner tube of a bicycle wheel is placed into the tire retaining space 33′ and is inflated. After inflation, the inner tube is fixed to the outer rim part 3′ by the fixing parts 313′.

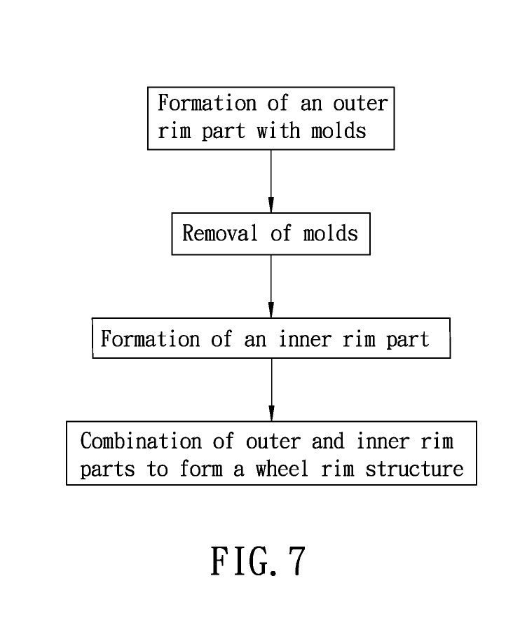

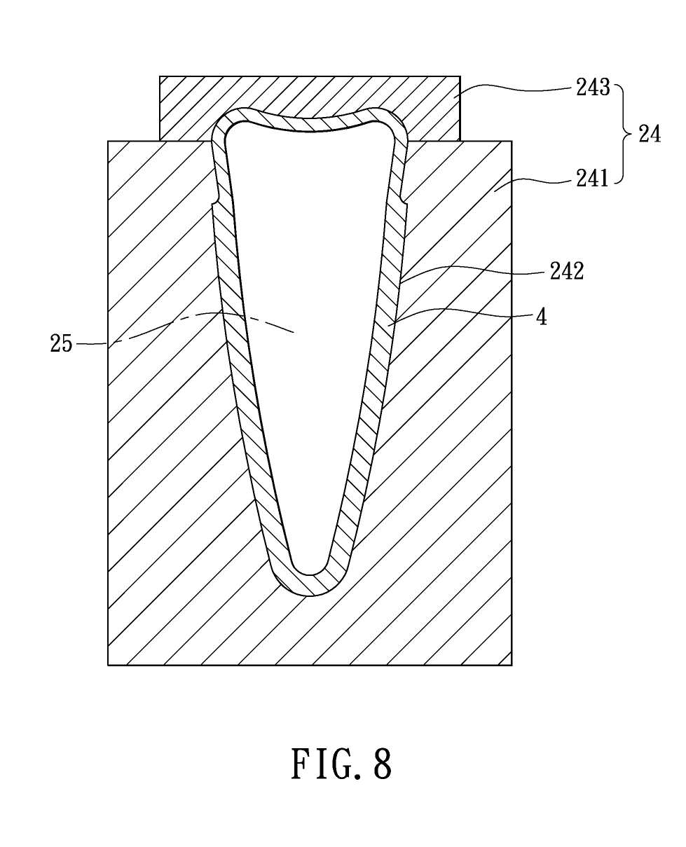

FIGS. 7 and 8 show the second preferred embodiment of a method for manufacturing a wheel rim of this invention. The second preferred embodiment is similar to the first preferred embodiment except that, in the step of forming the annular inner rim part 4′, the annular outer rim part 3′ is not used as a mold so that formation of the annular inner rim part 4′ and connection of the annular outer and inner rim part 3′, 4′ are conducted in separate steps.

Specifically, in the second preferred embodiment, the second mold 24 further includes a cover mold element 243. After the second prepreg preform 4 covered on the inflated air bag 25 is placed in the cavity of the mold body 241, the cover mold 243 then covers the mold body 241. The inflated air bag 25 pressures the second prepreg preform 4 to press the second prepreg preform 4 against the inner surface 242 of the mold body 241 and against the cover mold 243. Thermoforming is carried out to form the second prepreg preform 4 into the annular inner rim part 4′.

Finally the annular inner rim part 4′ and the annular outer rim part 3′ are connecting using thermoforming procedure so as to form the wheel rim.

In this invention, since the annular outer rim part 3′ is formed before the annular inner rim part 4′, a thermal resist resin material can be used as the resin of the first prepreg perform 3 without encountering the problem of the damage to the inflated air bag 25 in the prior art. Therefore, the wheel rim of this invention exhibits superior thermal resistance.

Moreover, since the annular outer rim part 3′ and the annular inner rim part 4′ are manufactured separately, discard of a complete wheel rim due to defect of one of the annular outer and inner rim part 3′, 4′ can be eliminated, thereby resulting in an increase in production yield and a decrease in manufacturing costs.

Since the core mold element 211 is tapered, the same can be easily moved to the un-wedging position, e.g., moved away from the annular mold elements 212.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for manufacturing a wheel rim including an annular inner and an annular outer rim part surrounding the annular inner rim part, the method comprising the following steps:
(a) providing a first mold assembly which includes an inner mold and an outer mold extending annularly around the inner mold, the outer mold having an annular first forming face to surround an annular second forming face of the inner mold;
(b) disposing annularly a first prepreg preform between the annular first and second forming faces, the first prepreg preform having a substantially H-shape in cross section and including two back to back disposed concaved faces that overlie annularly and respectively the first and second forming faces;
(c) causing the first and second forming faces to press the concaved faces and thermoforming the first prepreg preform to obtain the annular outer rim part;
(d) forming a second prepreg preform into the annular inner rim part; and
(e) combining the annular outer rim part with the annular inner rim part to form the wheel rim.

2. The method of claim 1, wherein the annular first forming face has an annular first end face and two first lateral faces, the annular second forming face has an annular second end face and two second lateral faces, the annular first and second end faces confronting each other in a radial direction, the first lateral faces extending radially outward from two opposite sides of the first end face, the second lateral faces extending radially inward from two opposite sides of the second end face.

3. The method of claim 2, wherein the outer mold is made from metal, and the inner mold is made from rubber.

4. The method of claim 3, wherein the outer mold includes two annular mold elements that are spaced apart from each other axially, and a core mold element disposed between the annular mold elements and movable between a wedging position and an un-wedging position, the annular mold elements respectively defining the first lateral faces and cooperatively defining the first end face, the core mold element being tapered radially and toward the first end face.

5. The method of claim 4, wherein the core mold element is spaced apart from the first end face in the wedging position.

6. The method of claim 3, wherein the first mold assembly further includes two side molds on two axially opposed sides of the outer and inner molds to press the first prepreg preform against the respective lateral faces of the outer and inner molds.

7. The method of claim 1, wherein the thermoforming is conducted at 180° C.

8. The method of claim 1, wherein steps (d) and (e) are conducted simultaneously, and include: covering the second prepreg preform onto an inflated air bag, placing the outer rim part and the second prepreg preform covered on the inflated air bag in a second mold in such a manner that the second prepreg perform is pressured by the inflated air bag to press against an inner surface of the second mold and against the outer rim part, and simultaneously thermoforming the second prepreg preform into the inner rim part and uniting the inner rim part with the outer rim part in the second mold.

9. The method of claim 1, wherein step (d) is conducted before step (e), and step (d) includes covering the second prepreg preform onto an inflated air bag, placing the second prepreg preform covered on the inflated air bag in a second mold in such a manner that the second prepreg perform is pressured by the inflated air bag to press against an inner surface of the second mold, and thermoforming the second prepreg preform into the inner rim part in the second mold

10. A wheel rim comprising:
an annular inner rim part including an annular body with a substantially hollow triangle shape in cross section, said annular body being tapered radially from an outer end thereof to an inner end thereof; and
an annular outer rim part having a substantially H-shape in cross section, and including two back-to-back disposed concaved faces, one of said concaved faces receiving and abutting against said outer end of said annular body;
wherein the wheel rim is made by the steps:
(a) providing a first mold assembly which includes an outer mold extending annularly around an inner mold, the outer mold having an annular first forming face to surround an annular second forming face of the inner mold;
(b) disposing annularly a first prepreg preform between the annular first and second forming faces, the first prepreg preform having a substantially H-shape in cross section and including two back to back disposed concaved faces that overlie annularly and respectively the first and second forming faces;
(c) causing the first and second forming faces to press the concaved faces of the first prepreg preform and thermoforming the first prepreg preform to obtain the annular outer rim part;
(d) forming a second prepreg preform into the annular inner rim part; and
(e) combining the annular outer rim part with the annular inner rim part to form the wheel rim.
